(19) United States
(12) Patent Application Publication
(10) Pub. No.: US 2024/0079675 A1
(43) Pub. Date: Mar. 7, 2024

(54) ACTIVATION TRAY FOR BATTERY CELL, AND SYSTEM FOR CHARGING/DISCHARGING BATTERY CELL, COMPRISING SAME

(71) Applicant: LG ENERGY SOLUTION, LTD., Seoul (KR)

(72) Inventors: Byoung Gu LEE, Daejeon (KR); Duk Hyun RYU, Daejeon (KR); Kwan Hee LEE, Daejeon (KR)

(73) Assignee: LG ENERGY SOLUTION, LTD., Seoul (KR)

(21) Appl. No.: 18/269,484

(22) PCT Filed: Sep. 2, 2022
(86) PCT No.: PCT/KR2022/013199

§ 371 Date: Jun. 23, 2023

(30) Foreign Application Priority Data
Sep. 3, 2021 (KR) 10-2021-0117449

(51) Int. Cl. H01M 10/6556; H01M 10/44; H01M 10/613; H01M 10/6567

(52) U.S. Cl. CPC H01M 10/6556; H01M 10/441; H01M 10/613; H01M 10/6567; H01M 2200/10

(57) ABSTRACT

A battery cell activation tray includes a tray main body including a plurality of accommodation grooves configured to receive a plurality of battery cells therein, the tray main body having an upper portion that is open, a lower plate located under the tray main body, the lower plate having a main flow path to allow a fluid to move therethrough, and a temperature controller fluidly connected to the main flow path to control a temperature of the fluid introduced into the main flow path. The fluid is introduced into the main flow path in the lower plate to control a temperature of the plurality of battery cells accommodated in the accommodation grooves of the tray main body.

### TECHNICAL FIELD

This application claims the benefit of priority based on Korean Patent Application No. 10-2021-0117449, filed on Sep. 3, 2021, and the entire contents of the Korean patent application are incorporated herein by reference.

The present invention relates to a battery cell activation tray and a battery cell charge/discharge system including the same.

### BACKGROUND ART

With the increases in technology development and demands in industrial fields such as mobile devices, automobiles, energy storage devices, and the like, the demand for batteries as energy sources is rapidly increasing, and among secondary batteries, many studies have been performed on lithium secondary batteries having high energy density and discharge voltage, and lithium secondary batteries have also been commercialized and are now widely used.

Generally, a lithium secondary battery is manufactured by embedding an electrode assembly composed of a positive electrode, a negative electrode, and a separator in a cylindrical or prismatic metal can or a pouch-shaped case of an aluminum laminate sheet, and injecting an electrolyte into the electrode assembly. The lithium secondary battery manufactured in this way can function as a battery only when the battery is activated by performing a predetermined charge/discharge process, and this process is referred to as a formation process or an activation process. A charge/discharge device is used in this activation process, and in a mass production process of the secondary battery, the charge/discharge device is provided to be capable of simultaneously charging and discharging a plurality of cells to increase productivity.

As described above, the secondary battery is manufactured through a plurality of manufacturing processes, and when each of processes such as an electrolyte injection process, an activation process, and the like is performed or the secondary battery is transferred in each process, an activation tray capable of accommodating a large amount of battery cells so that the plurality of battery cells can be easily and safely handled is used.

Generally, the battery tray includes a plurality of battery accommodation units each having shapes corresponding to shapes of battery cells or battery packs to be accommodated for mass production of the batteries.

FIG. 1 is a schematic view of a conventional cylindrical battery cell tray which accommodates a plurality of cylindrical batteries.

Referring to FIG. 1, the battery cell tray 10 is provided with accommodation units 11 for accommodating a plurality of batteries at a constant pitch. The accommodation units are formed at a constant pitch ‘a’ in each of an x-direction (horizontal direction) and a y-direction (vertical direction), and the batteries are accommodated one by one in the accommodation units.

Meanwhile, in this conventional battery cell tray, a polymer material having a light weight and a low thermal conductivity is used to facilitate transfer.

However, a difference of heat dissipation characteristics occurs according to a position of the battery cell as the number of battery cells accommodated in the battery cell tray increases. Specifically, when there is temperature deviation of a plurality of battery cells in an activation process of the battery cells, a capacity deviation of the battery cells can also occur. Accordingly, when whether a battery cell has a defect should be determined based on a measured value of the capacity of the battery cell during the activation process, a problem of a low selection capability for determining whether a battery cell has a defect can occur.

Accordingly, development of a technology for a device capable of improving temperature deviation between battery cells accommodated in a tray during an activation process of battery cells is necessary.

### DISCLOSURE

### Technical Problem

The present invention is to solve the above problems, and is directed to providing a battery cell activation tray capable of improving temperature deviation between battery cells accommodated in the tray during an activation process of the battery cells, and a battery cell charge/discharge system including the same.

### Technical Solution

The present invention provides a battery cell activation tray. In one example, the battery cell activation tray according to the present invention includes: a tray main body including a plurality of accommodation grooves configured to receive a plurality of battery cells therein, the tray main body having an upper portion that is open; a lower plate located under the tray main body, the lower plate having a main flow path to allow a fluid to move therethrough; and a temperature controller fluidly connected to the main flow path to control a temperature of the fluid introduced into the main flow path.

Further, the present invention provides a battery cell charge/discharge system including the above-described battery cell activation tray.

### Advantageous Effects

According to a battery cell activation tray and a battery cell charge/discharge system including the same of the present invention, there is an advantage in that a fluid flows into a main flow path in a lower plate and thus a temperature of a plurality of battery cells accommodated in accommodation grooves of a tray main body can be controlled to improve temperature deviation between the battery cells accommodated in the tray during an activation process.

### BRIEF DESCRIPTION OF THE DRAWINGS

FIG. 1 is a schematic view of a conventional cylindrical battery cell tray which accommodates a plurality of cylindrical batteries.

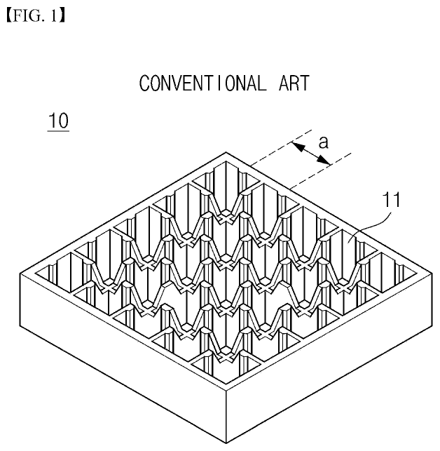

FIG. 2 is a schematic view illustrating a battery cell activation tray according to the present invention.

FIG. 3 is a plan view illustrating battery cells and a main flow path accommodated in the battery cell activation tray according to the present invention.

FIG. 4 is a conceptual diagram illustrating a configuration of a temperature controller in the battery cell activation tray according to the present invention.

FIG. 5 is a schematic view illustrating the battery cell activation tray according to the present invention.

FIG. 6 is a schematic view illustrating a battery cell activation tray according to the present invention.

### BEST MODE

The present invention provides a battery cell activation tray. In one example, the battery cell activation tray according to the present invention includes: a tray main body including a plurality of accommodation grooves capable of individually accommodating a plurality of battery cells and having a structure of which an upper portion is open; a lower plate disposed under the tray main body and having a structure in which a main flow path through which a fluid moves is formed; and a temperature controller fluidly connected to the main flow path to control a temperature of the fluid introduced into the main flow path.

In a specific example, in the battery cell activation tray according to the present invention, the fluid may be introduced into the main flow path in the lower plate to control a temperature of a plurality of battery cells accommodated in the accommodation grooves of the tray main body.

In one example, the main flow path installed in the lower plate may be formed with an inlet through which the fluid is introduced and an outlet through which the fluid is discharged, and may further include a circulation pump which communicates with the inlet and the outlet to transfer the fluid.

In this case, the main flow path may be disposed to pass through lower portions of the accommodation grooves of the tray main body.

In a specific example, the temperature controller may include: first and second sub-flow paths branched from the main flow path; a boiler which is fluidly connected to the first sub-flow path and heats the fluid; a cooling mechanism which is fluidly connected to the second sub-flow path and cools the fluid; and a flow path selection valve installed on the main flow path to selectively communicate the first or second sub-flow path with the main flow path.

Further, at least one region of the inlet and the outlet of the main flow path may include a temperature sensor which senses the temperature of the fluid.

Specifically, the flow path selection valve may selectively open the first sub-flow path when the temperature sensed by the temperature sensor is lower than a set temperature, and may selectively open the second sub-flow path when the temperature sensed by the temperature sensor exceeds the set temperature.

The temperature controller may control the temperature of the fluid introduced into the main flow path in a temperature range of 20° C. to 60° C.

In another example, the battery cell activation tray according to the present invention may include side walls disposed to surround side surfaces of the tray main body.

The tray main body and the side wall may include one or more thermal conductive materials of a thermal conductive filler and a thermal conductive polymer.

In this case, the side wall may have a height in a range of 80% to 120% with respect to a total height of the battery cell accommodated in the tray main body.

Meanwhile, the battery cell activation tray may include a side surface plate which comes into contact with an outer surface of the side wall. Further, the side surface plates may further include a flow path through which the fluid moves and a temperature controller which controls the temperature of the fluid introduced into the flow path therein.

The present invention provides a battery cell charge/discharge system including the above-described battery cell activation tray.

In a specific example, the charge/discharge system may include a charge/discharge device electrically connected to the plurality of battery cells accommodated in the tray main body.

### DETAILED DESCRIPTION OF THE PREFERRED EMBODIMENTS

Since the present invention may be variously changed and may have various embodiments, specific embodiments will be described in detail in the detailed description.

However, this is not intended to limit the present invention to the specific embodiments, and it should be understood that all modifications, equivalents, and substitutions included in the spirit and scope of the present invention are included.

In the present invention, it should be understood that terms such as “include” and “have” are intended to indicate that there is a feature, number, step, operation, component, part, or a combination thereof described on the specification, but do not exclude the possibility of presence or addition of one or more other features, numbers, steps, operations, components, or combinations thereof in advance.

Further, when a portion such as a layer, a film, a region, a plate, or the like is referred to as being “on” another portion, this includes not only a case in which the portion is “directly on” the other portion but also a case in which there is a still another portion therebetween. Likewise, when a portion such as a layer, a film, a region, a plate, or the like is referred to as being “under” another portion, this includes not only a case in which the portion is “directly under” the other portion but also a case in which there is still another portion therebetween. Further, being disposed “on” in the present application may mean that something is disposed on a lower portion or on an upper portion.

Hereinafter, a battery cell activation tray according to the present invention and a battery cell charge/discharge system including the same will be described in detail with reference to the drawings.

### First Embodiment

The present invention provides a battery cell activation tray as a first embodiment.

Battery Cell Activation Tray

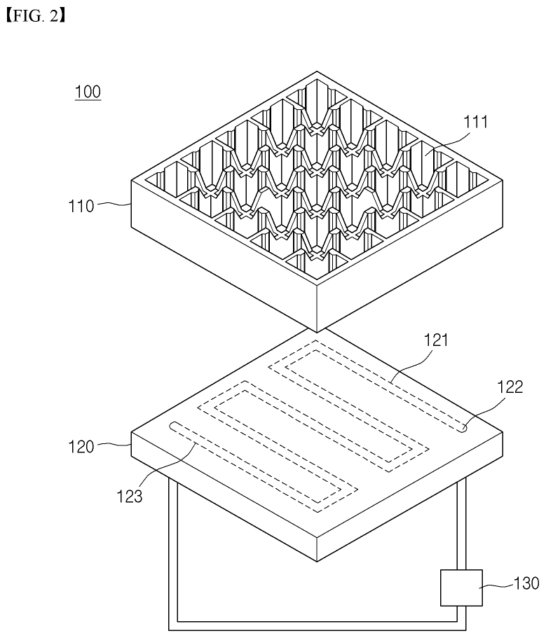

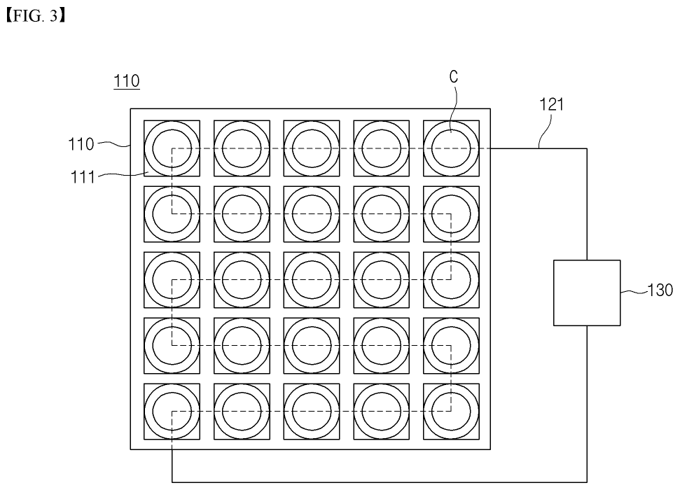

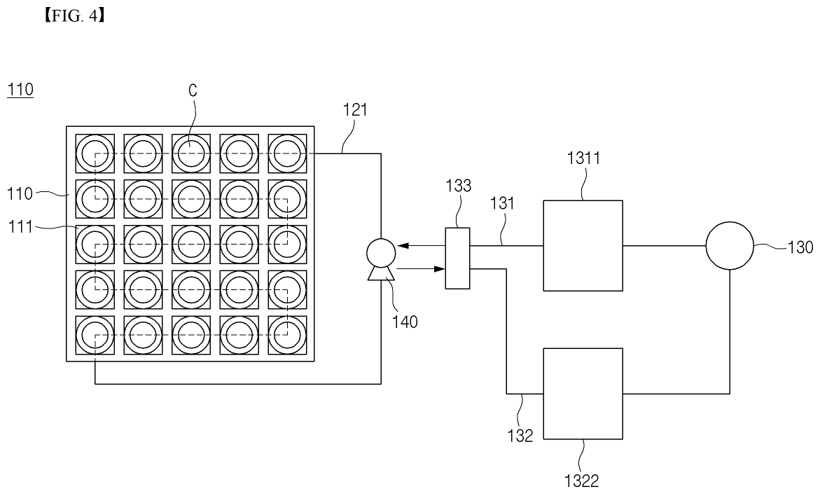

FIG. 2 is a schematic view illustrating the battery cell activation tray according to the present invention, FIG. 3 is a plan view illustrating battery cells and a main flow path accommodated in the battery cell activation tray according to the present invention, and FIG. 4 is a conceptual diagram illustrating a configuration of a temperature controller 130 in the battery cell activation tray according to the present invention.

Referring to FIGS. 2 to 4, a battery cell activation tray 100 according to the present invention includes: a tray main body 110 including a plurality of accommodation grooves 111 capable of individually accommodating a plurality of battery cells and having a structure of which an upper portion is open; a lower plate 120 disposed under the tray main body 110 and having a structure in which a main flow path 121 through which a fluid moves is formed; and a temperature controller 130 fluidly connected to the main flow path 121 to control a temperature of the fluid introduced into the main flow path 121.

In this case, the fluid may be introduced into the main flow path 121 in the lower plate 120 to easily control a temperature of the plurality of battery cells accommodated in the accommodation grooves 111 of the tray main body 110.

The tray main body 110 is a structure in a quadrangular frame shape of which an upper portion is open and in which the accommodation grooves 111 are formed, and each accommodation groove 111 has a structure partitioned by a partition wall or the like to be spatially separated from a neighboring accommodation groove 111. Further, the accommodation grooves are formed to correspond to the shapes of the battery cells to be accommodated, and thus the plurality of battery cells may be accommodated in the accommodation grooves partitioned from each other in a form of being spaced apart from each other.

The drawing illustrates that cylindrical battery cells are accommodated in the tray main body 110, but the present invention is not limited thereto. The tray main body 110 may accommodate cylindrical or prismatic battery cells.

Meanwhile, the tray main body 110 includes one or more thermal conductive materials of a thermal conductive filler and a thermal conductive polymer. The tray main body 110 may be formed of a general metal, or may be composed of a polymer as a main material. The tray main body 110 may include the above-described thermal conductive material when formed of the polymer. Since the polymer has a lighter weight than metal and thus a weight is light when the tray main body 110 is formed of the thermal conductive material based on the polymer, there is an advantage in that transfer and molding become easy.

For example, the tray main body 110 may be composed of a composite type material in which a filler having a thermal conductivity is mixed with a general polymer material. Here, the filler may include a silicon compound, an aluminum compound, a magnesium compound, a boron compound, or the like. For example, silicon oxide, aluminum oxide, boron nitride, aluminum nitride, magnesium oxide, magnesium carbon dioxide, magnesium hydroxide, or the like may be used as the filler included in the thermal conductive material. However, the present invention is not necessarily limited thereto, and in addition, various other fillers may be used as a material of a cartridge.

The polymer material used in the tray main body 110 may include various materials such as polypropylene, acrylonitrile butadiene styrene, polycarbonate, nylon, a liquid crystal polymer, polyphenylene sulfide, polyether ether ketone, and the like. Further, various other polymer materials may be used as cartridge materials of the present invention.

In addition, the thermal conductive material constituting the tray main body 110 may be formed of a material having a thermal conductivity of 1 W/mK or more. For example, this thermal conductive material may be formed of a polymer plastic material having a thermal conductivity of 2 W/mK to 20 W/mK, and the thermal conductive material may be formed of a thermal conductive polymeric plastic having a thermal conductivity of 5 W/mK or more.

Conventionally, in the case of plastic used as a material of the tray main body 110, generally, a thermal conductivity is only 0.1 to 0.4 W/mK. However, in the case of the tray main body 110 according to the present invention, since the polymer material having a higher thermal conductivity than this plastic is used, heat transfer and heat discharge may be performed by the tray main body 110, and heat transfer and heat discharge at the plurality of battery cells accommodated in the tray main body 110 may be easily performed.

Next, the lower plate 120 is further included under the tray main body 110. Specifically, the lower plate 120 may have a structure in which the main flow path 121 through which the fluid moves is formed.

An inlet through which the fluid is introduced may be formed at one end of the flow path, an outlet through which the fluid is discharged may be formed at the other end of the flow path, and the inlet and the outlet may communicate with a circulation pump. The circulation pump serves to adjust a flow rate and a flow velocity of the fluid flowing through the inlet of the flow path.

In this case, the main flow path 121 may be disposed to pass through lower portions of the accommodation grooves 111 of the tray main body 110. In a specific example, the fluid may alternately pass a first line in which the plurality of accommodation grooves 111 are disposed and a second line neighboring the first line to dissipate heat from the battery cells or to apply heat to the battery cells, and then may be discharged to the outlet. The inlet and the outlet may be formed to be connected to each other by the main flow path 121, and a liquid such as water, a coolant, or the like may be used as the fluid moving through the flow path. Specifically, since the liquid such as water, a coolant, or the like has high specific heat, a temperature of the liquid does not increase significantly even when heat generated by the battery cells is sufficiently absorbed, and thus secondary batteries may be uniformly cooled.

Further, the lower plate may be formed of the same material as the tray main body 110, and may easily maintain the temperature of the battery cells accommodated in the tray main body 110 by including a thermal conductive material.

In the battery cell activation tray 100 according to the present invention, the temperature controller 130 includes: first and second sub-flow paths 131, 132 branched from the main flow path 121; a boiler 1311 which is fluidly connected to the first sub-flow path 131 and heats the fluid; a cooling mechanism 1322 which is fluidly connected to the second sub-flow path 132 and cools the fluid; and a flow path selection valve 133 installed on the main flow path 121 to selectively communicate the first or second sub-flow path 131, 132 with the main flow path 121.

In a specific example, the flow path selection valve opens the first sub-flow path 131 when the boiler 1311 operates, opens the second sub-flow path 132 when the cooling mechanism 1322 operates, and operates simultaneously with the boiler 1311 or the cooling mechanism 1322 according to a set temperature of the temperature controller.

Meanwhile, one or more regions among the inlet and the outlet of the main flow path 121 may include a temperature sensor which senses the temperature of the fluid. For example, the temperature sensor may be installed at the outlet, or each of the inlet and outlet may include the temperature sensor.

For example, the flow path selection valve 133 may selectively open the first sub-flow path 131 when the temperature sensed by the temperature sensor is lower than the set temperature, and may selectively open the second sub-flow path 132 when the temperature sensed by the temperature sensor exceeds the set temperature.

In a specific example, the temperature of the fluid moving in the flow path may be in a range of 20° C. to 60° C., and the temperature controller 130 may control the temperature of the fluid introduced into the main flow path 121 in the temperature range of 20° C. to 60° C. For example, an aging process may increase the temperature of the fluid for impregnation of an electrolyte in the activation process of the battery cells, and since the temperature of the battery cells accommodated in the battery cell activation tray 100 rises in a charging/discharging process, the fluid may be cooled.

As described above, a circulation pump 140 may be provided on the main flow path to forcibly circulate the fluid.

Although not shown in the drawings, the cooling mechanism 1322 may include a compressor which compresses a refrigerant vaporized on the second sub-flow path 132, an evaporator which absorbs heat and vaporizes the refrigerant by exchanging heat with the second sub-flow path 132 through a heat exchanger, and a condenser which discharges the heat to the outside by condensing the compressed refrigerant. In a specific example, since the heat exchanger is provided so that the fluid in the second sub-flow path 132 passes therethrough and the evaporator passes therethrough, the evaporator cools the fluid by absorbing the heat from the heat exchanger. The temperature controller includes a temperature adjusting unit so that a user may set the temperature, and is electrically connected to an operation unit of the boiler 1311 and an operation unit of the cooling mechanism 1322 to operate the boiler 1311 the cooling mechanism 1322 according to a user's temperature setting.

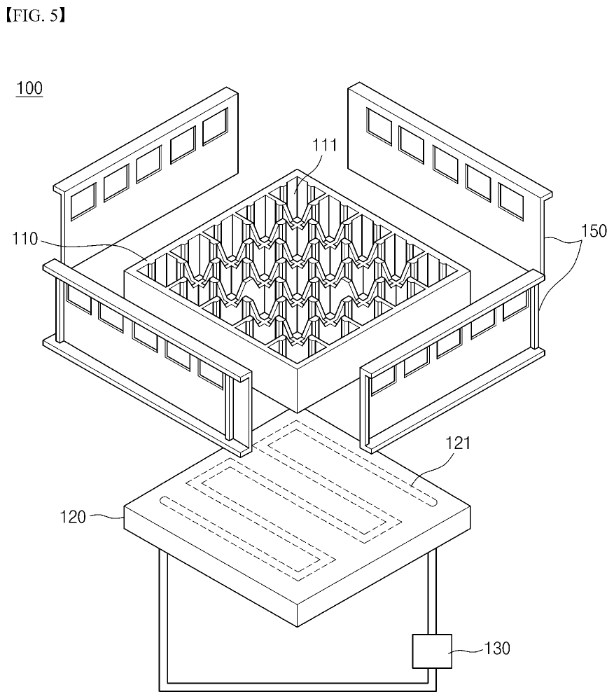

FIG. 5 is a schematic view illustrating the battery cell activation tray 100 according to the present invention.

Referring to FIG. 5, the battery cell activation tray 100 according to the present invention may further include side walls 150 disposed to surround side surfaces of the tray main body 110. For example, when the tray main body 110 has a quadrangular shape, the side walls 150 may be disposed to surround four surfaces of the tray main body 110.

Further, the side wall 150 may have a height in a range of 80% to 120% of a total height of the battery cells accommodated in the tray main body 110, and may have a height in a range of 85% to 110% or 90% to 105%, or a height of 105% of the total height of the battery cells to prevent the battery cells accommodated in the tray main body 110 from falling out when the battery cell activation tray 100 is transferred.

In addition, the side wall 150 may have a structure in which a plurality of openings are formed in an upper region, and the side wall 150 may include one or more thermal conductive materials of a thermal conductive filler and a thermal conductive polymer like the tray main body 110, and for example, may be manufactured of the same material as the tray main body 110. Since these configurations have been described above, detailed description thereof will be omitted.

The battery cell activation tray 100 according to the present invention may include the lower plate 120 having the flow path through which the fluid circulates under the tray main body 110 to easily control the temperature of the plurality of battery cells accommodated in the tray main body 110. Accordingly, the battery cell activation tray 100 according to the present invention has an advantage that temperature deviation between the battery cells accommodated in the tray during the activation process may be improved.

### Second Embodiment

The present invention provides a battery cell activation tray as a second embodiment.

Battery Cell Activation Tray

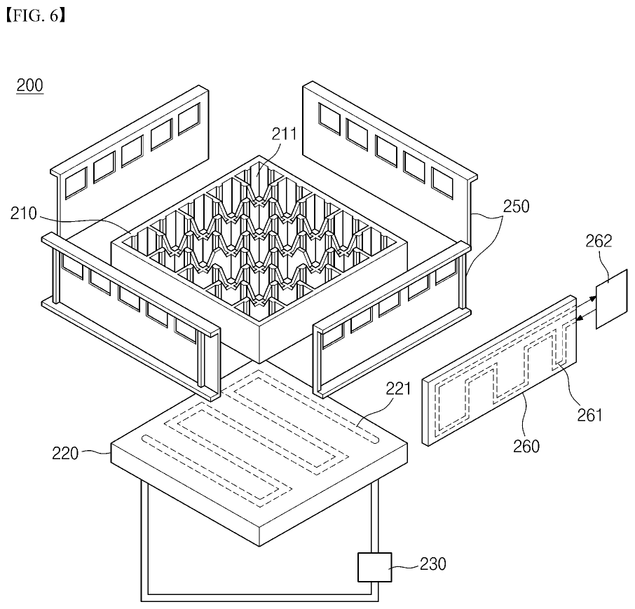

FIG. 6 is a schematic view illustrating a battery cell activation tray according to the present invention.

Referring to FIG. 6, a battery cell activation tray 200 according to the present invention includes: a tray main body 210 including a plurality of accommodation grooves 211 capable of individually accommodating a plurality of battery cells and having a structure of which an upper portion is open; side walls 250 disposed to surround side surfaces of the tray main body 210; a lower plate having 220 disposed under the tray main body 210 and having a structure in which a main flow path 221 through which a fluid moves is formed; and a temperature controller 230 fluidly connected to the main flow path 221 to control a temperature of the fluid introduced into the main flow path 221.

Further, the battery cell activation tray according to the present invention may include side surface plates 260 which come into contact with outer surfaces of the side walls 250, and the side surface plates 260 may further include flow paths 261 through which the fluid moves and a temperature controller 262 which controls the temperature of the fluid introduced into the flow paths 261 therein.

The flow paths 261 and the temperature controller 262 installed in the side surface plates 260 are different from the main flow path 221 and the temperature controller 230 installed in the lower plate 220, and may individually control the temperature.

The drawing illustrates that one side surface plate 260 is installed, but the side surface plates 260 may be installed on all side walls 250. For example, the side surface plate 260 may have a structure formed on a lower end of the side wall 250 with a predetermined length, and the side surface plate 260 may be installed to be hung on a step of the side wall 250.

Meanwhile, the flow paths 261 embedded in the side surface plates 260 may be disposed to pass through side surfaces of the accommodation grooves 211 of the tray main body 210. In a specific example, the flow paths 261 may be formed to pass through the side surface of one accommodation groove 211, and the flow paths 261 may be alternately formed to pass through the side surface of the accommodation groove 211 adjacent to the accommodation groove 211. Further, the fluid passing through the flow paths 261 may dissipate heat from the battery cells or apply heat to the battery cells, and then may be discharged to an outlet. An inlet and the outlet may be formed to be connected to each other by the main flow path 221, and a liquid such as water, a coolant, or the like may be used as the fluid moving through the flow paths 261.

In the battery cell activation tray 200 according to the present invention, the fluid of a predetermined temperature may be introduced into each of the above-described lower plate 220 and side surface plates 260 to easily control the temperature of the plurality of battery cells accommodated in the tray main body 210.

Further, the side surface plates 260 may include one or more thermal conductive materials of a thermal conductive filler and a thermal conductive polymer like the tray main body 210, and for example, may be manufactured of the same material as the tray main body 210.

Meanwhile, the side surface plates 260 are installed only on the side surfaces of the tray main body 210, but since the tray main body 210 has an excellent thermal conductivity, the temperature of the plurality of battery cells accommodated in the tray main body 210 may be effectively controlled. Since configurations of the tray main body 210, the lower plate 220, the side walls 250, the temperature controller 230, and the like have been described above, detailed description thereof will be omitted.

The battery cell activation tray 200 according to the present invention may include the lower plate 220 and the side surface plates 260 having the flow paths 261 through which the fluid circulates under the tray main body 210 and on the side surfaces of the tray main body 210 to easily control the temperature of the plurality of battery cells accommodated in the tray main body 210. Accordingly, the battery cell activation tray 200 according to the present invention has an advantage that temperature deviation between the battery cells accommodated in the tray during the activation process may be improved.

### Third Embodiment

The present invention provides a battery cell activation tray as a third embodiment.

Battery Cell Charge/Discharge System

The present invention relates to a battery cell charge/discharge system including the above-described battery cell activation tray. In a specific example, the battery cell charge/discharge system according to the present invention may include a charge/discharge device electrically connected to the plurality of battery cells accommodated in the tray main body.

Specifically, the charge/discharge device is electrically connected to electrode leads of the battery cells seated on the tray main body, and may supply charging power to the battery cells or receive discharging power from the battery cells. Here, supplying the charging power to the battery cells is not necessarily limited to supplying power sufficient to completely charge the battery cells. Since this means the same thing as receiving discharging power from the battery cells, repeated description will be omitted.

According to the battery cell charge/discharge system according to the present invention, there is an advantage that temperature deviation between the battery cells accommodated in the tray main body may be improved by controlling the temperature of the battery cells during a charging/discharging process of the plurality of battery cells accommodated in the tray main body.

The present invention has been described in more detail above through the drawings, the embodiments, and the like. However, since the configurations disclosed in the drawings, the embodiments, or the like disclosed in the present specification are only one embodiment of the present invention and do not represent all the technical spirit of the present invention, it should be understood that there may be various equivalents and modifications capable of substituting for those described above at the time of filing of the present application.

### REFERENCE NUMERALS

10, 100, 200: battery cell activation tray
110, 210: tray main body
111, 211: accommodation groove
120, 220: lower plate
121, 221: main flow path
122: inlet
123: outlet
130, 230: temperature controller
131: first sub-flow path
1311: boiler
132: second sub-flow path
1322: cooling mechanism
133: flow path selection valve
140, 240: circulation pump
150: side wall
260: side surface plate
261: flow path
262: temperature controller

1. A battery cell activation tray comprising:
a tray main body including a plurality of accommodation grooves configured to receive a plurality of battery cells therein, the tray main body having an upper portion that is open;
a lower plate located under the tray main body, the lower plate having a main flow path to allow a fluid to move therethrough; and
a temperature controller fluidly connected to the main flow path to control a temperature of the fluid introduced into the main flow path,
wherein the fluid is introduced into the main flow path in the lower plate to control a temperature of the plurality of battery cells accommodated in the accommodation grooves of the tray main body.

2. The battery cell activation tray of claim 1, wherein the main flow path includes:
an inlet through which the fluid is introduced;
an outlet through which the fluid is discharged; and
a circulation pump configured to communicate with the inlet and the outlet to transfer the fluid.

3. The battery cell activation tray of claim 1, wherein the main flow path is configured to pass below lower portions of the accommodation grooves of the tray main body.

4. The battery cell activation tray of claim 1, wherein the temperature controller includes:
a first sub-flow path and a second sub-flow path branched from the main flow path;
a boiler fluidly connected to the first sub-flow path, the boiler being configured to heat the fluid;
a cooling mechanism fluidly connected to the second sub-flow path, the cooling mechanism being configured to cool the fluid; and
a flow path selection valve on the main flow path to selectively communicate the first sub-flow path or the second sub-flow path with the main flow path.

5. The battery cell activation tray of claim 4, wherein at least one region of the inlet and the outlet of the main flow path includes a temperature sensor configured to sense the temperature of the fluid.

6. The battery cell activation tray of claim 5, wherein the flow path selection valve selectively opens the first sub-flow path when the temperature sensed by the temperature sensor is lower than a set temperature, and selectively opens the second sub-flow path when the temperature sensed by the temperature sensor exceeds the set temperature.

7. The battery cell activation tray of claim 1, wherein the temperature controller controls the temperature of the fluid introduced into the main flow path in a temperature range of 20° C. to 60° C.

8. The battery cell activation tray of claim 1, further comprising side walls disposed to surround side surfaces of the tray main body.

9. The battery cell activation tray of claim 8, wherein the tray main body and the side walls include at least one thermal conductive material of a thermal conductive filler and a thermal conductive polymer.

10. The battery cell activation tray of claim 8, wherein each side wall has a height in a range of 80% to 120% of a total height of the battery cells accommodated in the tray main body.

11. The battery cell activation tray of claim 8, further comprising at least one side surface plate configured to contact an outer surface of at least one side wall,
wherein the side surface plate further includes:
a flow path through which the fluid moves; and
a temperature controller configured to control the temperature of the fluid introduced into the flow path of the side surface plate.

12. A battery cell charge/discharge system comprising the battery cell activation tray according to claim 1.

13. The battery cell charge/discharge system of claim 12, further comprising a charge/discharge device configured to be electrically connected to the plurality of battery cells accommodated in the tray main body.
